(19) United States
(12) Patent Application Publication
(10) Pub. No.: US 2010/0202146 A1
(43) Pub. Date: Aug. 12, 2010

(54) Desk lamps with digital photo frames

(76) Inventor: Kash Gobindram, Amityville, NY (US)

Correspondence Address: Daniel P. Burke, Esq.;Daniel P. Burke & Associates, PLLC, 240 Townsend Square, Oyster Bay, NY, 11771, US

(21) Appl. No.: 12/322,723

(22) Filed: Feb. 6, 2009

(51) Int. Cl. F21V 21/00; F21V 33/00

(52) U.S. Cl. 362/249.03; 362/253

(57) ABSTRACT

Desk lamps comprising a base with a digital photo display screen integrally formed with the base. A movable support is movably connected to the base and supports an illumination portion, e.g. an LED lamp. The illumination portion is preferably movably connected to at least a portion of the support. The base advantageously comprises at least one mass storage device connector and a USB port. The disclosed bases also comprise user controls for controlling the operation of the lamp and the digital photo display screen.

### BACKGROUND

Digital photo display screens have become popular in recent years. Such screens are typically discrete devices designed as a typical photo frame to either be supported on a horizontal support such as a table or hung on a wall. Thus, such devices typically take up additional space when placed on a table or a desk.

It would be desirable to provide the benefits of a digital photo display screen without requiring additional space in a work environment or on a desk.

### SUMMARY OF THE INVENTION

The various embodiments of the present invention are directed to desk lamps comprising a base with a digital photo display screen integrally formed with, and most preferably movable relative to, the base. A movable support is movably connected to the base and supports a lamp, preferably an LED lamp. Additionally, the lamp is preferably movably connected to the support for movement relative to at least a portion of the support. The base advantageously comprises at least one input connector and/or a USB port, for connecting a source of electronic digital images, such as an SD (secure disk) card, a compact flash card or a computer, to the screen and the base. As used herein, the term “mass storage device connector” is meant to indicate structure for readily connecting a mass storage device including, but not limited to, a socket, a receptacle, a slot, and a plug. Images from the mass storage device and/or from one or more memory devices in the base, can be displayed on the digital display screen. The disclosed bases also comprise user controls for controlling the operation of the lamp, the digital photo display screen, and the electronic transfer of digital images.

According to one embodiment, the digital photo display screen is activated whenever the lamp is illuminated. According to other embodiments, the digital photo display screen is operable independently of the lamp.

### BRIEF DESCRIPTION OF THE DRAWINGS

FIG. 1 is a front view of one embodiment of the present invention with the screen in the lowered position.

FIG. 2 is a left side view of the embodiment of FIG. 1 with the screen in a raised position.

FIG. 3A is a rear view of the embodiment shown in FIG. 1.

FIG. 3B is a cross-sectional view taken along the lines 3B-3B of FIG. 2.

FIG. 3C is a front view of the lampshade of alternative embodiment of the present invention.

FIG. 4 is a partial top view of the device shown in FIG. 1.

FIG. 5 is a partial, bottom view of the embodiment of FIG. 1.

FIG. 6 is a top view of the base of the embodiment of FIG. 1 with the screen in the lowered position.

FIG. 7 is a perspective view of a second embodiment of the present invention.

FIG. 8 is a perspective view of a third embodiment of the present invention.

FIG. 9 is a perspective view of a fourth embodiment of the present invention.

### DETAILED DESCRIPTION

The lamps of the present invention are specifically desk lamps comprising a base having a digital photo display screen and an illumination portion movably connected to the base.

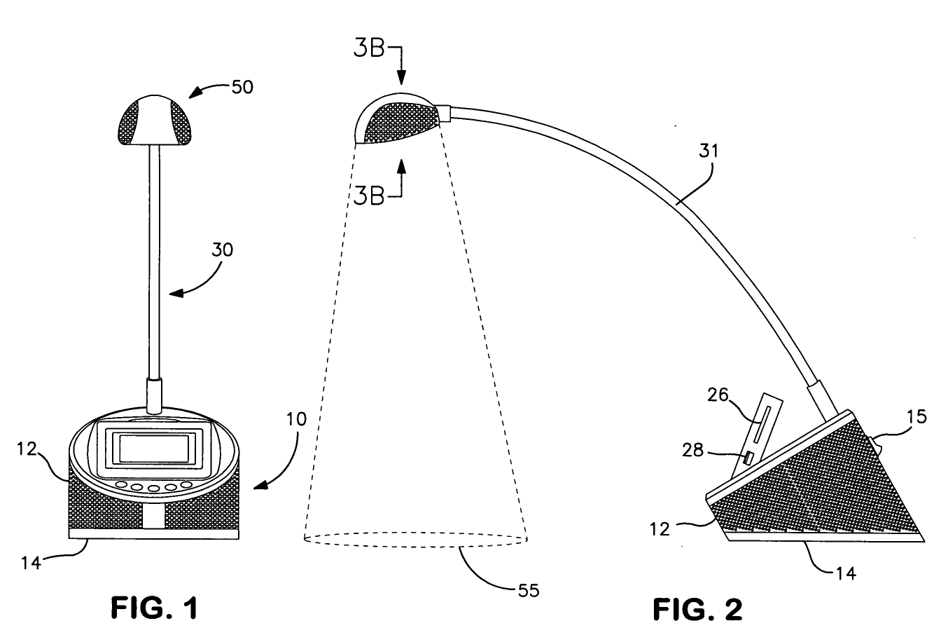

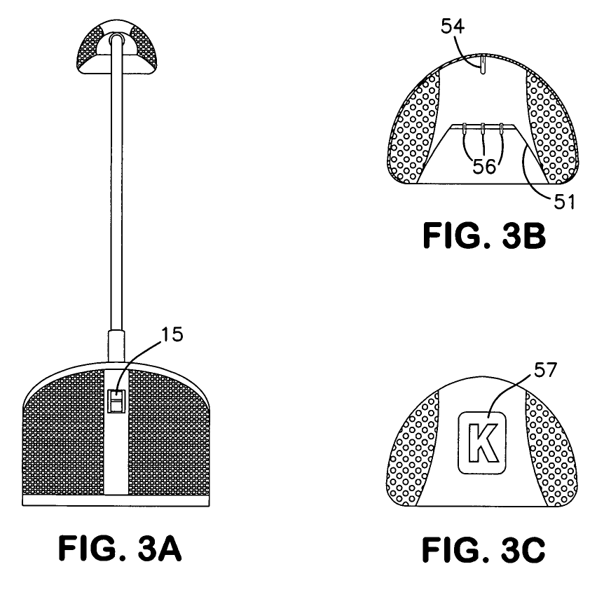

FIGS. 1-3B and 4-6 illustrate one embodiment of the present invention generally comprising a base 10, a movable connector 30 and an illumination portion 50. Base 10 comprises a housing 12 having a flat bottom 14 for supporting the base 10 on a horizontal surface such as a desk. As shown in FIGS. 2 and 3A, a toggle switch 15 is provided on the rear of the base 10 of this embodiment in order to control the operation of the illumination portion 50. For this and other illustrated embodiments, power for operating the illumination portion and the digital photo frame can be supplied by internal batteries, such as disposable batteries and/or rechargeable batteries, or from an external power source, e.g. a conventional AC plug (not shown).

According to this embodiment of the present invention, the connector 30 between the base 10 and the illumination portion 50 comprises a gooseneck connector 31 allowing illumination portion 50 to be readily moved by the user in any one or all of three dimensions. Thus, the illumination emanating from illumination portion 50 can be directed at the base 10 of the desk lamp to illuminate the control buttons and/or the digital display screen 22, and/or can be directed away from the base 10 (as illustrated in FIG. 2 as dashed cone 55) in order to avoid interference or creating glare with the images displayed on the digital display screen described below. For example, the illumination from the illumination portion 50 can be directed onto a book or papers in a manner which avoids direct illumination of the display screen. The illumination portion of this illustrated embodiment comprises a shade 52 comprising a central solid portion and perforated side portions as shown in the figures. FIG. 3B is a cross-sectional view taken along lines 3B-3B of FIG. 2. Shade 52 houses a reflector 51 and three rows, each comprising six LED's 56 extending through the top of a reflector 51. The positioning of LED's 56 and reflector 51 preferably allows the illumination emanating from the illumination portion 50 to be readily directed as illustrated in FIG. 2.

Additionally, according to this preferred embodiment of the present invention, the interior of shade 52 is illuminated by an additional, internal LED 54, the light from which diffuses out the holes in the perforated portion of lampshade 52.

FIG. 3C illustrates an alternative embodiment of the present invention wherein a selectively removable transparent or translucent insert is disposed within a window of the shade 52. In FIG. 3C, a translucent window 57 bearing an exemplary logo, in this case the letter K, is positioned in the forward portion of the shade. In this embodiment, illumination from LED 54 as well as illumination from LEDs 56 will illuminate the inner portion of translucent window 57. Since window 57 is selectively removable, other devices comprising designs, logos or the like can be readily inserted, as desired.

While different types of lamps can be utilized, inexpensive, commercially available LED devices providing fairly focused cones of illumination are particularly preferred as they provide a focused beam of light.

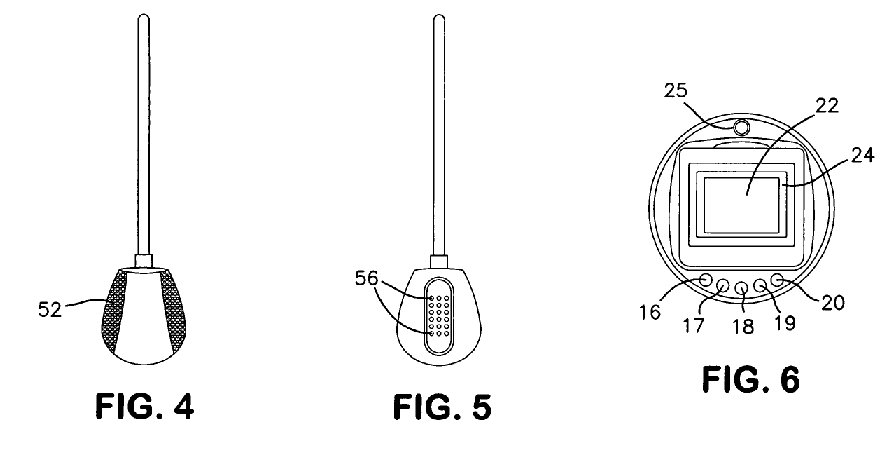

FIGS. 4 and 5 are top and bottom views, respectively, of a portion of the connector 30 and the illumination portion 50 of the illustrated desk lamp. FIG. 4 illustrates the top of a shade 52. As noted above, according to this embodiment of the present invention a plurality of light emitting diodes 56 are supported within shade 52 of illumination portion 50 and provide desired illumination. In this illustrated embodiment, eighteen LEDs 56 arranged in three rows are utilized. FIG. 6 is a top perspective view of the base 10 which comprises a movable digital display screen 22, a frame 24, a receptacle 25 for connector 30, and control buttons 16, 17, 18, 19 and 20 for controlling the operation of the digital photo display.

According to this illustrated embodiment, button 16 is a power button to turn the digital display on and off. Button 17 is a “left” navigation control which controls the display and the depression of which prompts the display of the previous image or icon. Button 18 is a “right” navigation control which prompts the display of the next image. Button 19 is an “exit” control which exits the current page on the screen. Button 20 is an “enter” and screen display button. Depressing button 20 initiates an initial navigation screen for controlling the display of images, selection of storage device or external source, as well as for moving digital images from one storage device to another. Navigation of screens is also assisted with buttons 17 and 18 which allow input for the user to move to a previous icon or the next icon, respectively. Depressing button 20 momentarily acts as an “enter” function or confirms the selection of a desired activity.

With reference again to FIGS. 1 and 2, digital display screen 22 is pivotally supported for movement from a lowered position (FIG. 1) to a raised position (FIG. 2). In a raised position, slot 26 which is a mass storage device connector designed to receive an SD card, MMC card or MS card, is readily accessible. Additionally, with reference to FIG. 2, port 28 is designed to receive a USB cable to connect the digital photo frame to an external device such as a personal computer. Plugging a USB cable into port 28 will cause screen 22 to display a query asking the user whether that connection is desired and/or to provide other information regarding the interaction between the desk lamp and the personal computer. While the mass storage device connector 26 and USB port 28 are disposed on the side of display screen 22 in this illustrated embodiment, it is also within the scope of the present invention to locate either or both of these connectors on other portions of the desk lamp.

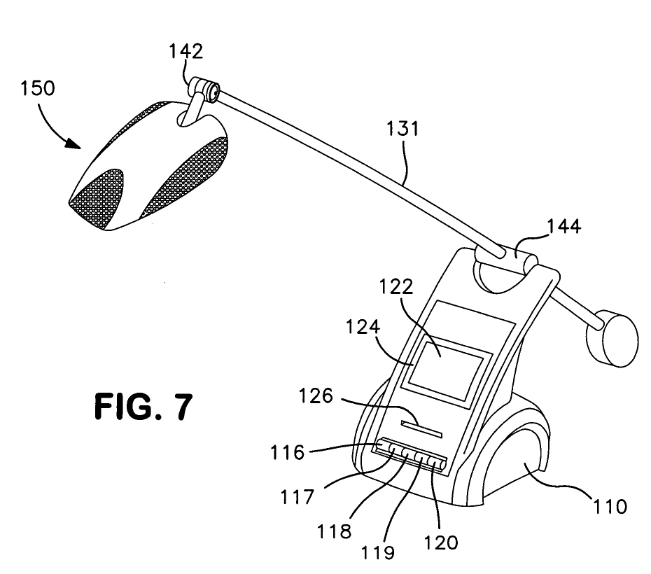

FIG. 7 shows an alternate embodiment of the present invention wherein an illumination portion 150 is movably connected to a weighted support rod 131. The illumination portion 150 is connected to a distal portion of the support rod 131 by a first pivotal connection 142 which has sufficient friction to support illumination portion 150 at any desired orientation relative to support rod 131, while allowing a user to easily aim light emanating from the illumination portion 150 to any desired location. According to this embodiment, the LEDs are recessed in the illumination portion 50 in order to allow the direct illumination from the LEDs to be directed where desired and kept from shining directly onto areas where direct illumination is not desired.

A proximal portion of support rod 131 is connected to a portion of base 110 by a second pivotal connection 144 which similarly has sufficient friction to support the support rod 131 at any angle while permitting rod 131 to be selectively pivoted by the user relative to base 110 within a wide range of angles. The specific construction details of pivotal supports 142 and 144 are within the skill of one of ordinary skill in the art and are, therefore, not described in detail herein.

In addition to rotational movement about second pivotal support 144, support rod 131 can be translated relative to pivotal support 144 in order to effectively lengthen or shorten the portion of the support rod 131 between first pivotal support 142 and the second pivotal support 144. Therefore, illumination portion 150 can be moved closer to base 110 or further away from base 110, as desired by the user. The connection between support rod 131 and second pivotal support 144 which permits translational movement of the support rod 131 relative to second pivotal support 144 is also not shown and can take various forms known in the art.

The embodiment of the present invention shown in FIG. 7 also comprises a display screen 122, a frame 124, a mass storage device connector 126 and control buttons 116-120 which function in the same way as the embodiment shown in FIG. 1. While it is deemed most desirable to provide input controls wherein the user responds to messages appearing on the digital display screen, other forms of controls can also be used. Input slot 126 is advantageously designed to receive numerous types of digital photo storage devices. A USB port (not shown) is provided on the rear of the base.

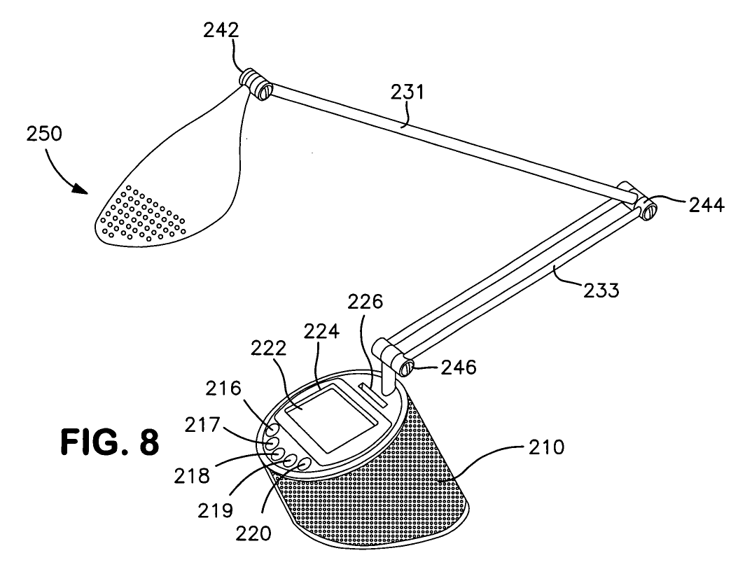

FIG. 8 illustrates a third embodiment of the present invention which is generally similar to the previous embodiments and comprises two connecting rod portions which are hingedly connected to each other and are pivotally connected to an illumination portion 250 and a base 210, respectively. This embodiment comprises a base 210 comprising a display screen 222, a frame 224, a mass storage device connector 226, and five input buttons 216-220. Illumination portion 250 is pivotally connected to upper support rod 231 by first frictional hinge connector 242. The proximal end of upper support rod 231 is connected to a second frictional hinge connector 244, which is connected to a distal portion of lower connector 233. Lower connector 233 is in turn pivotally connected to base 210 by third frictional hinge connector 246. The illustrated lower connector comprises a double rod arrangement. Illustrated frictional hinge connectors 242, 244 and 246 have the same functionality as described above with respect to hinge 142 described above.

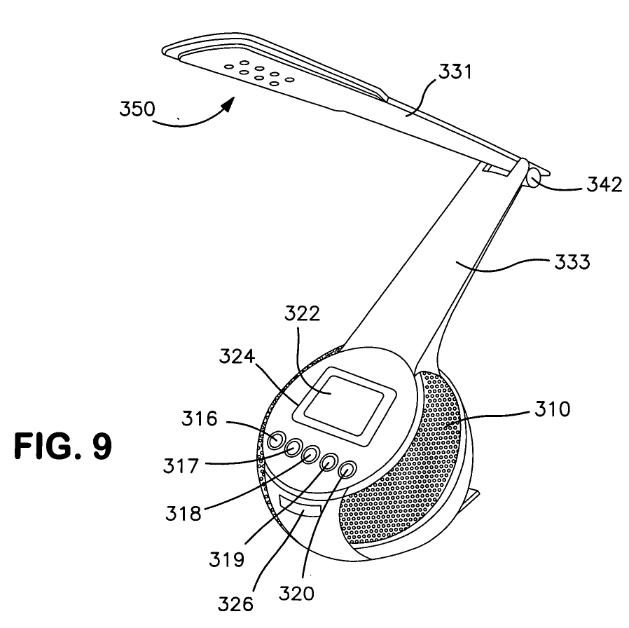

FIG. 9 illustrates a fourth embodiment of the present invention comprising a base 310, a lower support arm 333 and an upper support arm 331. Lower support arm 333 can be integrally formed with base 310 or secured to base 310 so that there is no relative movement between lower arm 333 and 310. As illustrated in FIG. 9, lower support arm extends on a generally oblique angle upwardly and rearwardly from base 310. For example, lower support arm 333 can extend at an angle of about 30° to about 75° from the horizontal surface upon which base 310 normally rests. Upper support arm 331 supports flush mounted LED's which form the illumination portion 350 and is pivotally connected to lower support arm 333 by a frictional hinge 342. The embodiment of FIG. 9 also comprises a display frame 324, an input slot 326 and a plurality of input control buttons 316-320.

The input control buttons illustrated on FIG. 9 control both the illumination portion 350 and the function of the display screen 322. According to one embodiment of the present invention, the display screen 322 is only functional when the illumination portion of the lamp has been activated. According to other embodiments, the illumination portion and the photo display portion are independently operable.

The connector which is provided for receiving digital images from a digital storage device can take a form other than a slot or a USB port and can be in any desired form. For aesthetic purposes the connector and/or plurality of connectors can be covered either when in use and/or when not in use. According to another embodiment, in addition to still photos, the screen can also provide a video display with accompanying audio sound through speakers preferably located in the base (not shown).

1. An illumination and display device comprising:
a base;
a digital photo display screen;
an input connector for connecting a source of electronic digital images to said base, said connector in electronic communication with said display screen;
a source of illumination; and
a movable support movably connected to said base, said source of illumination connected to said support and movable from a first position to at least one second position which is spaced further from said base than said first position.

2. An illumination and display device according to claim 1 wherein said input connector comprises a USB port.

3. An illumination and display device according to claim 1 wherein said input connector comprises a compact flash port.

4. An illumination and display device according to claim 1 further comprising user controls for controlling the operation of said source of illumination and said digital photo display screen.

5. An illumination and display device according to claim 1 wherein said digital photo display screen is integrally formed with said base.

6. An illumination and display device according to claim 1 wherein said source of illumination is pivotally connected to said support.

7. An illumination and display device according to claim 1 wherein said source of illumination comprises a lamp.

8. An illumination and display device according to claim 7 wherein said lamp comprises at least one light emitting diode.

9. An illumination and display device according to claim 7 wherein said lamp comprises a plurality of light emitting diodes.

10. An illumination and display device according to claim 1 wherein said input connector comprises a mass storage device connector.

11. An illumination and display device according to claim 1 wherein said base comprises at least one user input control.

12. An illumination and display device according to claim 1 wherein said base comprises a plurality of user input controls.

13. An illumination and display device according to claim 1 further comprising a switch for controlling the operation of said source of illumination independently from the operation of said digital photo display screen.

14. An illumination and display device comprising:
a base;
a digital photo display screen;
an input connector for connecting a source of electronic digital images to said base, said connector in electronic communication with said display screen;
a source of illumination; and
a movable support movably connected to said base, said source of illumination movably connected to said support and movable from a first position to at least one second position which is spaced further from said base than said first position.

15. An illumination and display device according to claim 14 wherein said source of illumination is pivotally connected to said support.

16. An illumination and display device according to claim 14 wherein said digital photo display screen is integrally formed with said base.

17. An illumination and display device according to claim 14 wherein said input connector comprises a mass storage device connector.

18. An illumination and display device according to claim 14 wherein said source of illumination comprises at least one light emitting diode.

19. An illumination and display device according to claim 14 further comprising user input controls for controlling the operation of said source of illumination and said digital photo display screen.
